(19) United States
(12) Patent Application Publication
(10) Pub. No.: US 2012/0083231 A1
(43) Pub. Date: Apr. 5, 2012

(54) TUNER

(75) Inventor: Shinji Kurihara, Ota-shi (JP)

(73) Assignee: ON SEMICONDUCTOR TRADING, LTD., Hamilton (BM)

(21) Appl. No.: 13/241,397

(22) Filed: Sep. 23, 2011

(30) Foreign Application Priority Data
Sep. 30, 2010 (JP) 2010-220335

(51) Int. Cl. H04B 1/18

(52) U.S. Cl. 455/190.1

(57) ABSTRACT

Noise in an audio output is reduced even if a mixing signal leaks to another tuner. A broadcast wave is received from a broadcast station by an antenna to which a mixing signal is mixed by a mixer to obtain an IF signal and demodulated by a demodulator. An oscillator outputs a mixing signal having a frequency difference of at least a barely audible frequency within an audio frequency band from any broadcast station center frequency allocated at a predetermined frequency spacing, the mixing signal is mixed with the signal received by the antenna, and the IF signal is obtained.

### CROSS-REFERENCE TO RELATED APPLICATION(S)

The entire disclosure of Japanese Patent Application No. 2010-220335 filed on Sep. 30, 2010, including specification, claims, drawings, and abstract, is incorporated herein by reference in its entirety.

### BACKGROUND

1. Technical Field

The present invention relates to a tuner for receiving audio broadcasts, such as FM radio and AM radio.

2. Background Art

Heretofore, a tuner for receiving broadcast waves in an FM radio has an IF frequency set to 10.7 MHz. Then, an IF signal is extracted using a ceramic filter used for IF filters with the center frequency of a pass-band signal at 10.7 MHz.

Here, when the IF frequency is set to 10.7 MHz, the RF mixing frequency (oscillation frequency of local oscillator) becomes “tuning frequency±10.7 MHz”. The frequency relationship of the “tuning frequency+10.7 MHz” is shown in FIG. 1 and the frequency relationship of the “tuning frequency−10.7 MHz” is shown in FIG. 2.

For example, when the tuning frequency of 76 MHz is converted in frequency to the IF at the upper setting, the mixing frequency is set to 76 MHz+10.7 MHz=86.7 MHz as shown in FIG. 3.

As shown in FIG. 4, the Japanese FM broadcast station frequency band is from 76 MHz to 90 MHz and regulations allow broadcast stations to be allocated with broadcast frequencies having 100 kHz spacing. The mixing frequency of 86.7 MHz is within the FM broadcast station frequency band and coincides with the broadcast station center frequency of 86.7 MHz.

Furthermore, as shown in FIG. 5, when a frequency mixer is used, a phenomenon occurs where the mixing signal (local oscillation signal) leaks to the antenna terminal. This phenomenon is called local oscillator (LO) leakage and occurs through a capacitive coupling or board. Generally, since LO leakage differs from the self tuning frequency, the LO leakage does not interfere with reception.

However, when multiple tuners are used, there are instances where LO leakage becomes a problem. For example, as shown in FIG. 6, when two tuners are used where a tuner 1 is tuned to 76 MHz and a tuner 2 receives 86.7 MHz, the mixing frequency of tuner 1 and the receiving frequency of tuner 2 coincide. A block diagram of an instance where multiple tuners are provided is shown in FIG. 7.

In this case, the LO leakage of tuner 1 interferes with the receiving frequency of tuner 2 resulting in an interference signal. The IF signal is shown as a path of leakage of the mixing signal in FIG. 13.

Furthermore, the mixing frequency is usually generated by a crystal oscillator with PLL synchronization. The crystal oscillator has a oscillation frequency tolerance and a tolerance also develops for the mixing frequency with PLL synchronization. As shown in FIG. 8 and FIG. 9, when the mixing frequency of tuner 1 deviates by 1 kHz due to tolerance, for example, the LO leakage interference signal interfering with the receiving frequency of tuner 2 also deviates by 1 kHz. When an audio signal is demodulated in this state with tuner 2 having LO leakage interference, a problem occurs where a 1 kHz noise is generated. As shown in FIG. 10, this is due to the frequency of the difference between the mixing signal and the tuning center frequency of tuner 2 being demodulated as noise.

### SUMMARY OF THE INVENTION

The present invention is a tuner for receiving by an antenna a broadcast wave from a broadcast station, mixing a mixing signal thereto to obtain an IF signal, and demodulating the broadcast wave where the mixing frequency having a frequency difference of at least a barely audible frequency within an audio frequency band from any broadcast station center frequency allocated at a predetermined frequency spacing is mixed with the signal received by the antenna to obtain the IF signal.

According to the present invention, it is possible to eliminate or reduce the influence of LO leakage of the mixing frequency on the audio noise of another tuner even when using multiple tuners.

### BRIEF DESCRIPTION OF THE DRAWINGS

FIG. 1 shows a frequency relationship of tuning frequency+10.7 MHz.

FIG. 2 shows a frequency relationship of tuning frequency−10.7 MHz.

FIG. 3 shows a frequency relationship when converting tuning frequency of 76 MHz to IF at the upper setting.

FIG. 4 shows the Japanese FM broadcast station frequency band.

FIG. 5 shows a mixing signal leaking to an antenna terminal when using a frequency mixer.

FIG. 6 shows tuner 1 tuned to 76 MHz and tuner 2 receiving 86.7 MHz.

FIG. 7 is a block diagram of multiple tuners.

FIG. 8 shows the mixing frequency of tuner 1 deviating by +1 kHz due to tolerance and interfering with the receiving frequency of tuner 2.

FIG. 9 shows the mixing frequency of tuner 1 deviating by −1 kHz due to tolerance and interfering with the receiving frequency of tuner 2.

FIG. 10 shows an audio signal being demodulated with tuner 2 having LO leakage interference.

FIG. 11 shows a frequency relationship during audio demodulation (difference frequency between mixing signal and tuning center frequency of tuner 2 is outside audible frequency band).

FIG. 12 shows a relationship during audio demodulation (frequency difference between mixing signal and tuning center frequency of tuner 2 is in a barely audible frequency band).

FIG. 13 shows the path of mixing signal leakage when using multiple tuners.

FIG. 14 shows an example configuration of an IF filter built into an IC.

FIG. 15 shows the frequency characteristic of a ceramic filter.

FIG. 16 shows the frequency characteristic of multiple filters.

FIG. 17 shows an example configuration using a VICS tuner and an audio tuner.

FIG. 18 shows an example configuration using an RDS tuner and an audio tuner.

FIG. 19 shows an example configuration using an audio tuner and another audio tuner.

FIG. 20 shows a partial configuration of a radio comprising multiple tuners relating to the embodiment.

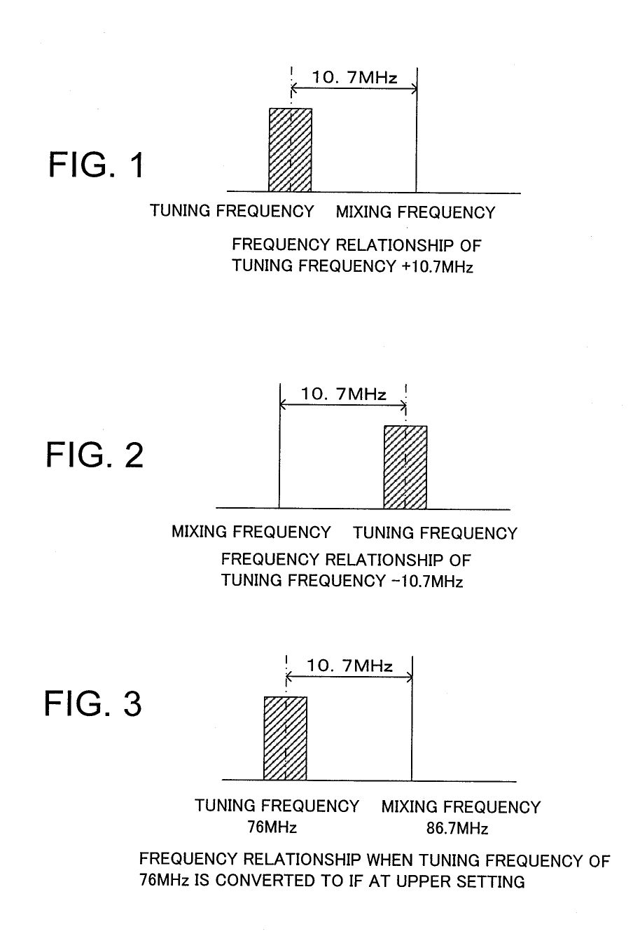

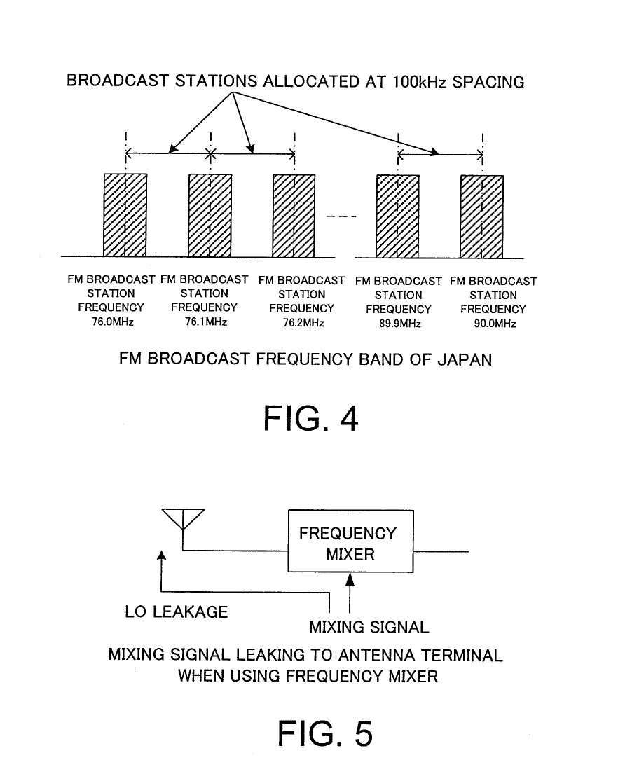

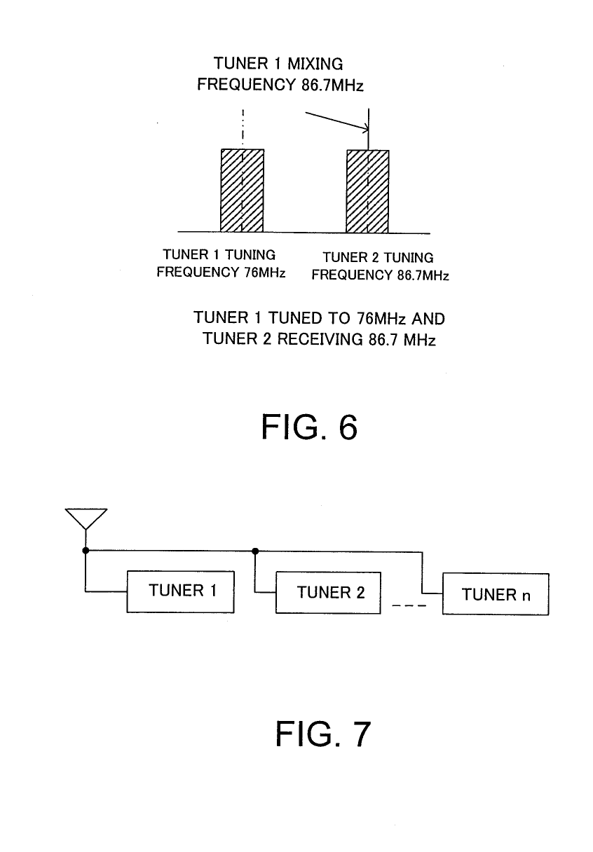

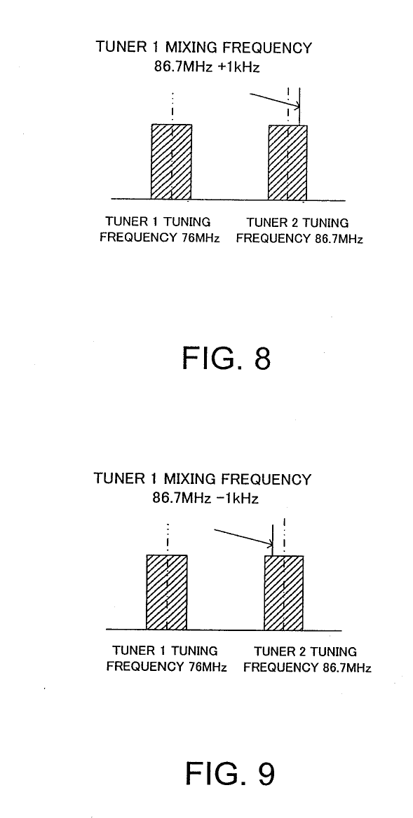

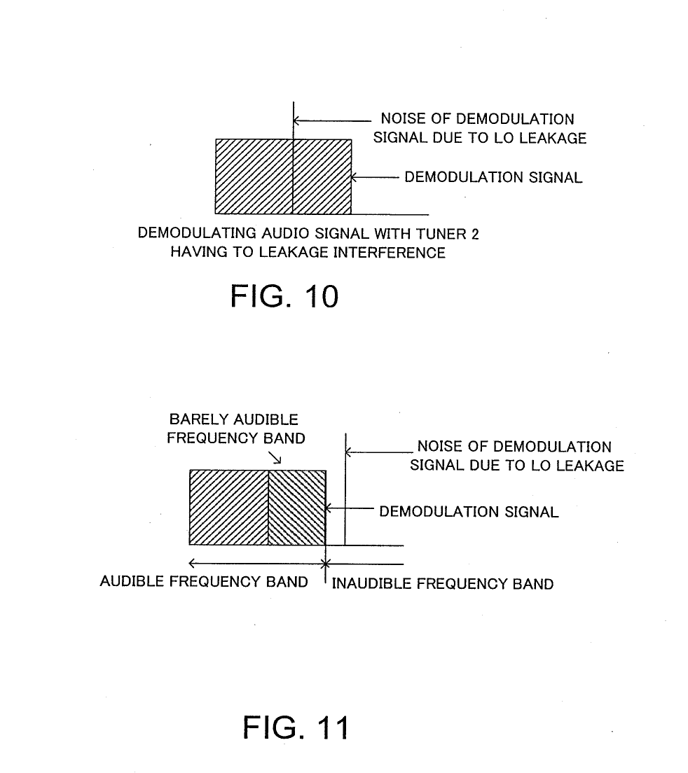

### DETAILED DESCRIPTION

Embodiments of the present invention will be described hereinafter with reference to the attached drawings.

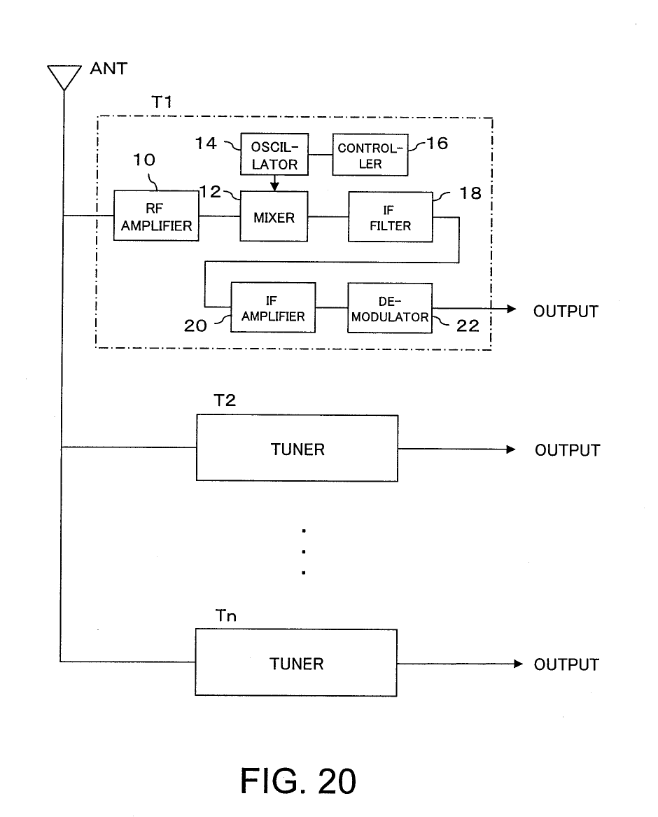

A partial configuration of a radio comprising multiple tuners is shown in FIG. 20. To an antenna ANT are connected n number of tuners T1 to Tn. Each tuner T1 to Tn has the same configuration.

At each tuner, a received signal from the antenna ANT is input by an RF amplifier 10 where it undergoes RF amplification and the amplified received signal is input by a mixer 12 where it is mixed with a mixing signal from an oscillator 14. Here, the oscillator 14 is controlled by a controller 16 so that the oscillation frequency is controlled and the frequency of the mixing signal is controlled. To the controller 16 is supplied a broadcast station selection signal and the controller 16 controls the oscillator to oscillate at a frequency shifted by only the IF frequency with respect to the frequency of selected broadcast station.

The signal mixed with the mixing signal has the IF signal extracted at an IF filter 18. Therefore, a selected broadcast station signal (IF signal) converted to the IF frequency is obtained at the output of the IF filter 18. The IF signal is amplified at an IF amplifier 20, then demodulated at a demodulator 22 so that an output signal is obtained. The demodulation signal is basically an audio signal and supplied to a speaker causes audio to be output. In a tuner for FM multiplex broadcasts, the demodulated signal in the demodulator is data which is output to a screen or provided to a navigation device.

A case will be considered here, for example, using two tuners with a tuner T1 tuned to 76 MHz and a tuner T2 receiving 76.6 MHz.

In the embodiment is employed an IF frequency separated by at least an audio frequency band away from a frequency where a broadcast wave exists. For example, the IF frequency is set to 575 kHz and the mixing frequency of the tuner T1 is 76.575 MHz. Thus, the LO leakage frequency interfering with the receiving frequency of tuner T2 also becomes 76.575 MHz.

Furthermore, when the IF frequency is 10 MHz or lower, the IF filter 18 composed conventionally of an external ceramic filter can be easily built into an IC. Thus, compared to the conventional external ceramic filter, the following effects can be obtained: (i) reduction of external components, (ii) layout of board to which IC is to be mounted is unaffected due to the filter being built into the IC, (iii) reduction of external component cost and reduction of component mounting cost due to reduction of external components can be realized.

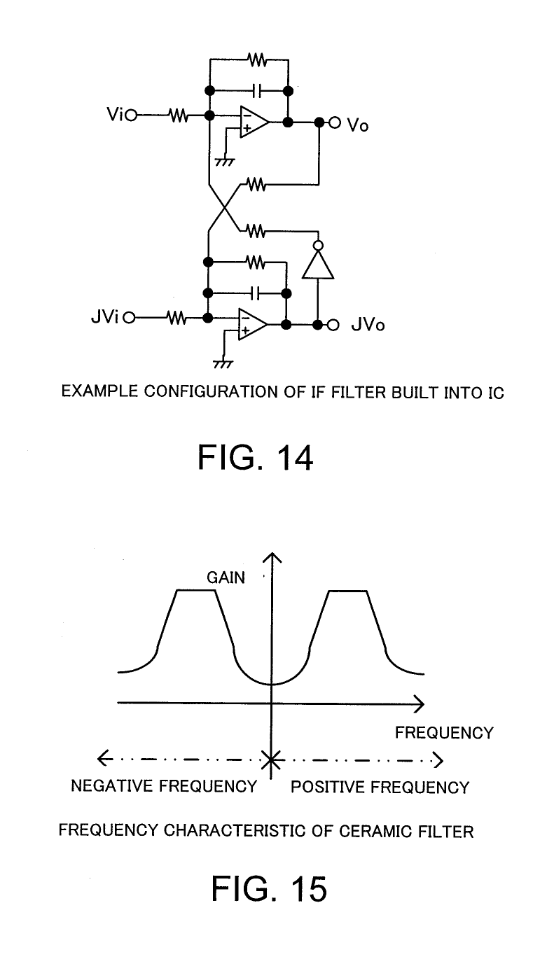

FIG. 14 shows an example configuration of the IF filter 18 built into the IC. Furthermore, various types of active filter configurations are known so that by adjusting the characteristic of each element, a filter can be configured for extracting an arbitrary frequency.

As clearly illustrated, the filter is composed of an active filter, which can be configured from capacitors, resistors, and active elements, which can be built in by an ordinary IC fabrication process. A cascade connection of the filter in FIG. 14 can improve the selectivity of the filter. Furthermore, the active filter of FIG. 14 is composed of a complex filter.

A filter, such as a ceramic filter, is known to have a frequency characteristic such as that shown in FIG. 15. In this manner, the filter characteristic shows the negative frequency and the positive frequency having a specular relationship. For example, in the case of the lower mixing frequency, the negative frequency is an image frequency. Since the frequency characteristic of FIG. 15 also includes a frequency band where a signal passes in negative frequency, interference results if there is a signal, such as of a broadcast station, at that frequency.

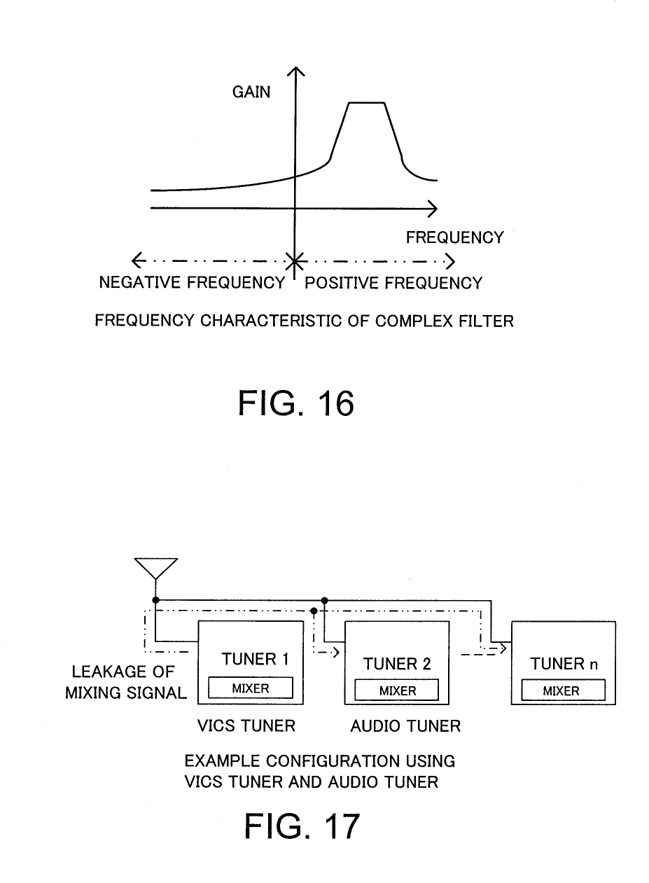

A frequency characteristic of a complex filter including the active filter of FIG. 14 is shown in FIG. 16. As shown, the complex filter does not exhibit a specular relationship between the negative frequency and the positive frequency. Thus, since there is no signal pass-band in the image frequency band of the negative frequency, interference is less likely to occur even when there is a signal, such as of a broadcast station, in the image frequency.

As described hereinabove, the tuner T2 is tuned to 76.6 MHz and the frequency of the mixing signal in the tuner T1 is 76.575 MHz. Therefore, when the tuner T2 performs audio demodulation in a state of LO leakage interference, a 25 kHz noise is generated from the tuner T2. This is due to the frequency of the difference between the interference signal and the tuning center frequency of the tuner T2 being 25 kHz. FIG. 11 shows the frequency relationship during audio demodulation. In this manner, the 25 kHz noise generated at the tuner T2 is inaudible to human ears. Namely, the 25 kHz noise exceeds the audible range of human hearing.

The audible frequency range of human hearing is said to be 20 Hz to 15 kHz or 20 Hz to 20 kHz. Furthermore, when audio frequencies exceed 10 kHz, they become inaudible at normal volumes and the sense of hearing becomes less sensitive.

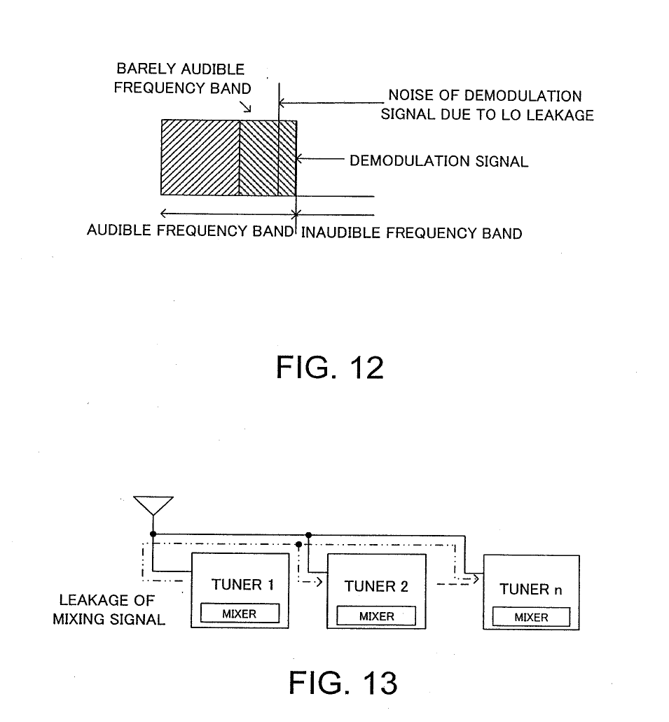

FIG. 12 shows a frequency diagram during audio demodulation when the mixing frequency is set to a barely audible frequency (such as 10 kHz or higher frequency) difference from the broadcast station center frequency.

In this manner, any adverse effect on the audio output due to LO leakage can be eliminated or reduced by setting the mixing frequency to a frequency difference greater than or equal to the audio frequency band from the broadcast station center frequency or setting the mixing frequency to a barely audible frequency difference (such as 10 kHz or higher frequency) from the broadcast center frequency so that when multiple tuners are used the mixing frequency interfering with another tuner due to LO leakage is inaudible or barely audible.

For example, by setting the 10 kHz position of the IF frequency between 10 kHz to 90 kHz, the frequency of the mixing signal will always be separated by 10 kHz to 90 kHz with respect to the center frequency of a broadcast station allocated at 100 kHz spacing and the noise due to LO leakage interference will be at least in a frequency band of 10 kHz so that there is substantially no problem in terms of audible noise.

The abovementioned effect is obtained even by setting the IF frequency to 10.71 MHz to 10.79 MHz. In this case, if a ceramic filter having a slightly wide pass-band is used, a conventional ceramic filter used for IF filters can be used.

Furthermore, the example using multiple tuners is an increasing trend. FIG. 17 shows an example configuration comprising a VICS tuner 1 for VICS service for streaming traffic congestion information in FM multiplex broadcasts and an ordinary audio tuner 2. In this example, traffic congestion information is acquired by the VICS tuner 1 and simultaneously the audio tuner 2 performs reception with the same antenna.

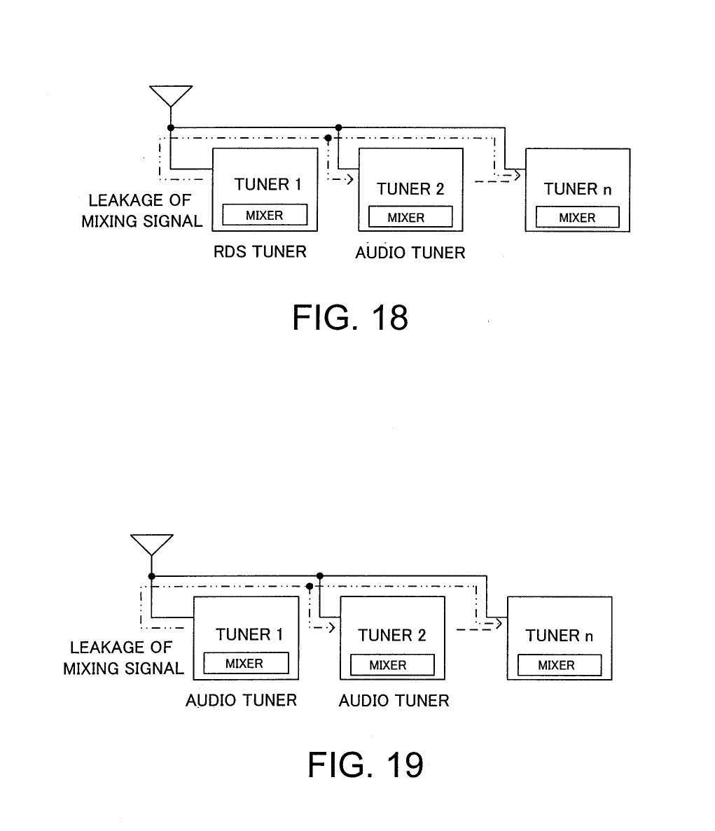

FIG. 18 shows an example configuration comprising an RDS tuner 1 and the audio tuner 2. This is an example configuration where traffic information and data are received by the RDS tuner 1 and simultaneously the audio tuner 2 performs reception with the same antenna.

FIG. 19 shows an example configuration of the audio tuner 1 and the audio tuner 2. In this example, while audio is demodulated by the audio tuner 1 in a case where the broadcast environment has deteriorated, such as in terms of field intensity, multi-path, fading or nearby interference, audio demodulation is performed without interruption even when a signal of another broadcast station, which is broadcasting identical broadcast content, is demodulated and output by the other tuner 2.

Even in this case, according to the embodiment, the IF frequency is set so as to be separated from the broadcast station frequency by at least the audio frequency band or by a frequency that is normally inaudible. Thus, even if the mixing signal leaks to another tuner, an adverse effect on the demodulated audio signal at the tuner to where the leak reached can be effectively prevented.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A tuner for receiving by an antenna a broadcast wave from a broadcast station, mixing a mixing signal thereto to obtain an IF signal, and demodulating the broadcast wave;
wherein the mixing signal having a frequency difference of at least a barely audible frequency within an audio frequency band from any broadcast station center frequency allocated at a predetermined frequency spacing is mixed with the signal received by the antenna to obtain the IF signal.

2. The tuner according to claim 1, wherein:
said frequency difference of at least a barely audible frequency within an audio frequency band is 10 kHz or higher.

3. The tuner according to claim 1, wherein:
a mixing signal having a frequency difference of at least a frequency of an audio frequency band from any broadcast station center frequency allocated at a predetermined spacing is mixed to obtain the IF signal.

4. Said frequency difference of at least a frequency of an audio frequency band is 20 kHz or higher.
